(19) United States
(12) Patent Application Publication
(10) Pub. No.: US 2015/0134363 A1
(43) Pub. Date: May 14, 2015

(54) INTERACTIVE PATIENT DISCHARGE SYSTEM AND METHODS

(71) Applicant: MEDICONNEX, LLC, RAMSEY, NJ (US)

(72) Inventor: David A. GIBSON, Forest hill, MD (US)

(73) Assignee: MEDICONNEX, LLC, RAMSEY, NJ (US)

(21) Appl. No.: 14/539,394

(22) Filed: Nov. 12, 2014

Related U.S. Application Data
(60) Provisional application No. 61/903,217, filed on Nov. 12, 2013.
(60) Provisional application No. 61/909,180, filed on Nov. 26, 2013.

(51) Int. Cl. G06F 19/00

(52) U.S. Cl. CPC G06F 19/322; G06F 19/327
USPC 705/3

(57) ABSTRACT

The present disclosure describes systems and methods for the interactive discharge of patients from hospitals and other healthcare facilities. An exemplary system according to the present disclosure may comprise at least one hospital server configured to store at least one patient's health information; at least one clinician device configured to communicate via a communications network with the hospital server; at least one clinician interface configured to conduct an interactive patient discharge process, wherein the clinician interface may be a web-based portal accessible via the clinician device; and at least one global server configured to provide a gateway for external communications.

An exemplary system according to the present disclosure may further comprise at least one discharge notification device configured to receive one or more messages via the global server; at least one patient device configured to communicate via a communications network with at least one of a global server and the hospital server; and at least one patient interface configured to allow patients to communicate with at least one of the hospital server and the global server, wherein the patient interface may be a web-based portal accessible via the patient device.

### RELATED ITEMS

This application claims priority to U.S. Provisional Application Nos. 61/903,217, filed Nov. 12, 2013, and 61/909,180 filed Nov. 26, 2013, the contents of which are herein incorporated by reference in their entirety.

### FIELD OF THE INVENTION

The present invention relates to the field of healthcare management, and more particularly, to systems and methods of interactively managing the patient discharge process from hospitals and other healthcare facilities.

### BACKGROUND OF THE INVENTION

The hospital discharge process is a critical moment in the patient care cycle. When patients are discharged from hospitals or other healthcare facilities, they must understand how to manage their recovery process—e.g., what types of progress they should observe with respect to various symptoms, when and how medications should be taken, and when they should contact a physician or other care provider.

In the present state of the art, a patient is given discharge instructions, through a non-interactive process, in the form of printed materials just prior to his discharge from the hospital. These printed materials generally describe the conditions for which the patient was treated, any post-discharge actions the patient should take, and list telephone numbers the patient should call for various types of questions. The discharging clinician may ask the patient if he or she has any questions about the discharge instructions, but typically the patient is not afforded the time to review and digest the materials prior to discharge. Furthermore, the patient often has a very high stress level at the time of his discharge. Under these conditions, the patient's comprehension and retention of information is very poor, resulting in approximately 30% of patients being unable to recall that they were provided post-discharge instructions forty-eight hours later. Further difficulties exist when the discharging clinician and patient speak different languages, sometimes requiring a clinician to present instructions in a language that either they or the patient may not be able to read or understand.

A patient's misunderstanding of his discharge instructions can have serious consequences, including relapse, complications, and other health conditions ultimately requiring the patient to be readmitted to the hospital. Readmissions are a poor outcome for not only the patient, but also for hospitals and insurers. For example, patient readmissions tend to decrease patient satisfaction scores. If these scores are published, they often negatively affect the number of private payer patients who choose to be admitted to a particular hospital. Low patient satisfaction scores can also affect a hospital's Medicare reimbursement rate.

Given the current state of the art, however, readmissions are not uncommon. For example, studies have shown that nearly 1 in every 5 Medicare patients returns to the hospital within 30 days for additional care. These readmissions alone cost the Center for Medicare and Medicaid Services hospital trust fund about $18 billion each year. In an effort to pass some of these costs back on to the hospitals, in 2012 the federal Government, through the Affordable Care Act, began levying readmission penalties on hospitals responsible for the discharge and subsequent readmission of certain categories of patients. By 2015, hospitals having higher-than-expected readmittance rates for certain categories of patients will lose up to 3% of their annual Medicare reimbursements.

Many healthcare experts believe that a significant portion of hospital readmissions could be prevented if hospitals did more to educate patients and ensure their ability to care for themselves both prior to and following discharge. Thus, there exists in the art a need for systems and methods for improving patient education at the time of discharge, as well as systems and methods for monitoring and ensuring patient compliance with discharge instructions.

### BRIEF SUMMARY OF THE INVENTION

The present disclosure is best understood with reference to the claims, the entire specification, and the drawings submitted herewith, which describe the systems and methods of the present disclosure in greater detail. The summary is merely intended to convey aspects of illustrative embodiments.

The present disclosure describes systems and methods for the interactive discharge of patients from hospitals and other healthcare facilities. An exemplary system according to the present disclosure may comprise at least one hospital server configured to store at least one patient's health information; at least one clinician device configured to communicate via a communications network with the hospital server; at least one clinician interface configured to conduct an interactive patient discharge process, wherein the clinician interface may be a web-based portal accessible via the clinician device; and at least one global server configured to provide a gateway for external communications.

An exemplary system according to the present disclosure may further comprise at least one discharge notification device configured to receive one or more messages via the global server; at least one patient device configured to communicate via a communications network with at least one of a global server and the hospital server; and at least one patient interface configured to allow patients to communicate with at least one of the hospital server and the global server, wherein the patient interface may be a web-based portal accessible via the patient device.

### BRIEF DESCRIPTION OF THE DRAWINGS

In the accompanying drawings that form a part of the specification and are to be read in conjunction therewith, the present invention is illustrated by way of example and not limitation, with like reference numerals referring to like elements, wherein:

FIG. 1 shows the components of an exemplary system according to the present disclosure.

FIGS. 2A-2B show flow charts depicting an exemplary method of discharging a patient according to the present disclosure.

FIG. 3 shows a screen capture of an exemplary clinician interface after a patient has been selected for discharge.

FIG. 4 shows a screen capture of an exemplary clinician interface after a patient's contact information has been populated into the interface.

FIGS. 5A-5D show screen captures of an exemplary clinician interface during the step of setting up a patient's healthcare team.

FIGS. 6A-6B show screen captures of an exemplary clinician interface during the step of creating discharge instructions for a patient.

FIGS. 7A-7E show screen captures of an exemplary clinician interface during the step of associating one or patient actions with a patient.

FIGS. 8A-8B show screen captures of an exemplary clinician interface during the step of associating a medical coach with a patient.

FIGS. 9A-9B show screen captures of an exemplary clinician interface during the step of a clinician reviewing a compliance checklist.

FIGS. 10A-10C show screen captures of an exemplary clinician interface during the step of a clinician and a patient performing a final review and acknowledgment of the discharge.

### DETAILED DESCRIPTION

In the following detailed description, numerous specific details are set forth in order to provide a thorough understanding of embodiments of the disclosure. In other instances, well known structures, interfaces, and processes have not been shown in detail, as they are understood by those of skill in the art. It is intended that no part of this specification be construed to effect a disavowal of any part of the full scope of the disclosure.

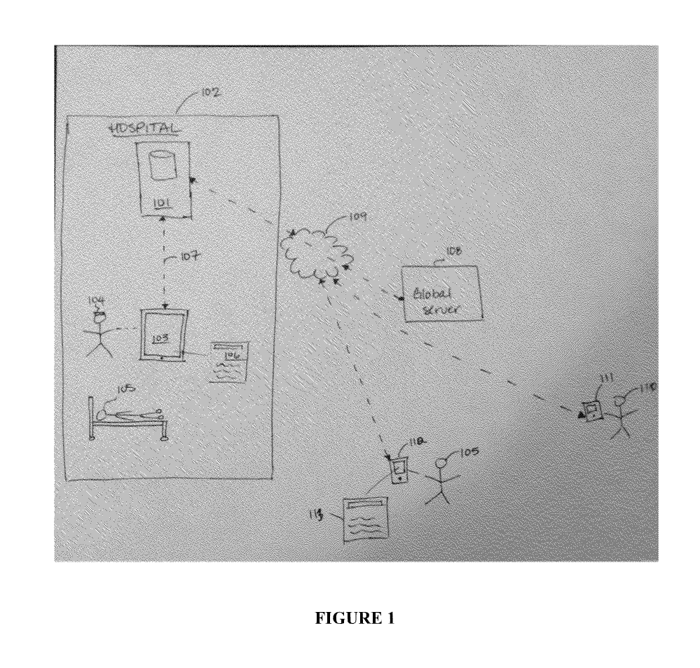

The present disclosure describes systems and methods for the interactive discharge of patients from hospitals and other healthcare facilities. In one exemplary embodiment according to the present disclosure, as shown on FIG. 1, an interactive patient discharge system 100 may comprise at least one hospital server 101. Each hospital server 101 may store patient health records, discharge information, and other information relevant to patients who have been admitted or are currently admitted to the corresponding hospital 102.

An interactive patient discharge system (sometimes referred to herein as “IPDS”) 100 according to the present disclosure may further comprise at least one clinician device 103, which may be used by a clinician 104 to assist a currently admitted patient 105 with the discharge process. The clinician device 103 may be any suitable computing device capable of interacting with a clinician interface 106, including but not limited to a workstation, a laptop, a tablet (such as an iPad®), a mobile phone, or an electronic book device such as a Kindle®.

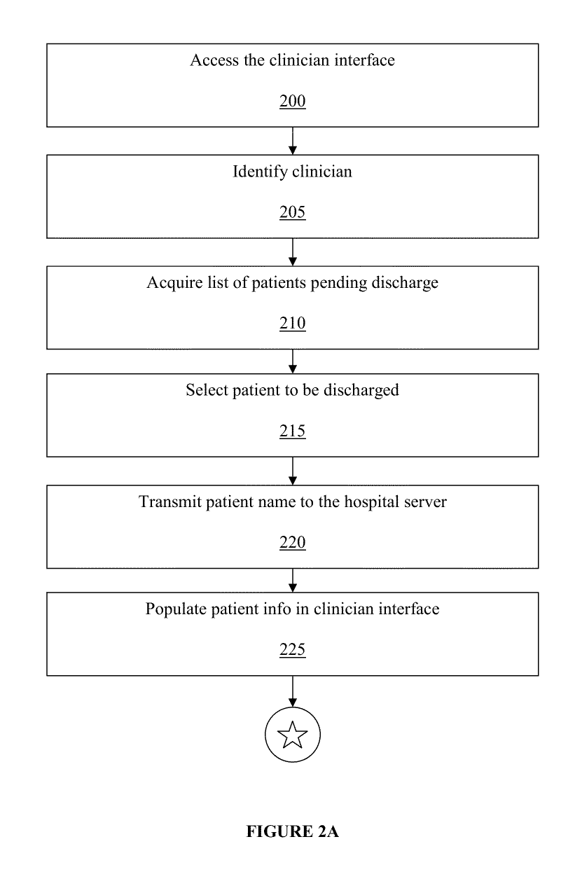

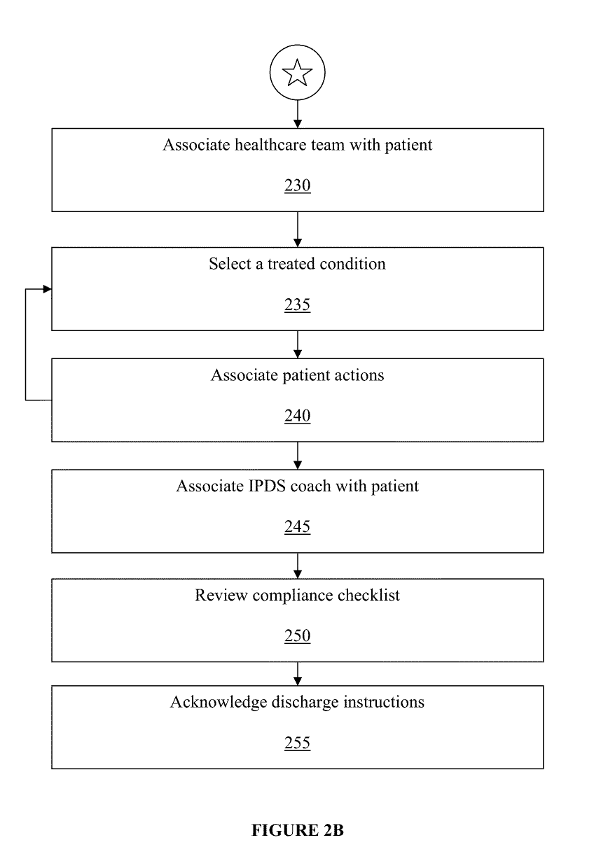

An interactive patient discharge system according to the present disclosure may further comprise at least one clinician interface 106. The clinician interface 106 may be a web-based portal accessible on the clinician device 103 using, for example, an Internet browser pre-installed on the clinician device 103. The clinician interface 106 may provide a mechanism by which a clinician 104 may obtain information from and transmit information to one or more hospital servers 101 via one or more hospital networks 107. Using the clinician interface 106, the clinician 104 may be able to:
Access patient 105 and hospital information stored on one or more hospital servers 101;
Conduct an interactive discharge process with the patient 105 in order to create a customized patient action plan (e.g., as described in the exemplary method described with respect to FIGS. 2A and 2B below);
Save and/or modify any patient discharge instructions on one or more hospital servers 101;
Translate discharge instructions into different languages; and/or
Update patient compliance information.

An interactive patient discharge system 100 according to the present disclosure may further comprise at least one global server 108 suitable for providing a gateway for external communications, i.e., communications with parties outside the hospital networks, such as discharged patients. For example, a global server 108 may be any form of computing device connected to the Internet 109. In one embodiment, the global server 108 may send discharge notifications (text messages, e-mails, etc.), such as appointment reminders or medication reminders, to one or more patients 105 and/or one or more medical coaches 110, via a discharge notification device 111.

An interactive patient discharge system 100 may further comprise at least one discharge notification device 111 configured to receive one or more messages from a clinician 104 or a hospital server 101 via the global server 108. In certain embodiments, wherein a medical coach 110 has been associated with a patient 105, the medical coach 110 may possess such a discharge notification device 111 and receive one or more messages regarding the patient's post-discharge care. These messages may be in any suitable format including, but not limited to, the form of voicemail, email, text message, telecommunications device for the deaf (TDD), or a combination thereof. In certain embodiments, the discharge notification device 111 may be further configured to send one or more responses, such as compliance alerts, to a clinician or a hospital server 101 via the global server 108. A discharge notification device 111 may be any form of computing device suitable for receiving and transmitting such messages, including but not limited to a workstation, a laptop, a tablet, a mobile phone, or an electronic book device.

An interactive patient discharge system 100 may further comprise at least one patient device 112 configured to interact with a patient interface 113. An exemplary patient device 112 may be any of a workstation, a laptop, a tablet, a mobile phone, or an electronic book device, though it will be understood by one having ordinary skill in the art that these examples are not meant to be limiting. The patient interface 113 may be a web-based portal allowing patients to transmit and/or receive information from a hospital server 101 and/or the global server 108. For example, patients may use a patient interface 113 to request access to their discharge and other medical information as stored on one or more hospital servers 101, or to access the global server 108 to configure the format of and schedule of any discharge notifications which may be sent to a discharge notification device 111. The patient interface 113 may be configured to transmit and receive information via an external communication network, such as the Internet 109. It will be understood that in certain embodiments the patient device 112 and the discharge notification device 111 may be a unitary electronic device, e.g., they may be the same device, or they may be housed in the same physical device body.

FIGS. 2A and 2B depict an exemplary method for the discharge of a patient 105 from a hospital according to the present disclosure. As shown on FIG. 2A, at step 200, a clinician 104 may use a clinician device 103 to access the clinician interface 106. At step 205, the clinician 104 may uniquely identify him or herself to the clinician interface 106 or, as appropriate, to the hospital server 101; for example, the clinician 104 may type in a username and password using a virtual or real keypad on the clinician device 103, which may be verified on the clinician device 103 or by reference to credentials stored on the hospital server 101. (In certain embodiments, the clinician may be required to reauthenticate him or herself if the IPDS is inactive for ten minutes or more.) It will be understood that clinician authentication can be performed in suitable manner already known and understood in the art or developed in the future.

At step 210, the clinician interface 106 may access the hospital server 101 to acquire a list of patients 105 pending discharge and may present this list on the clinician device 103 for observation by the clinician 104. Alternatively, the clinician may manually enter a patient name, relevant contact information and/or medical history. It will be understood that in various embodiments the list may be presented in a text list format, while in others it may be graphical, and in still others it may be a combination of text and graphics.

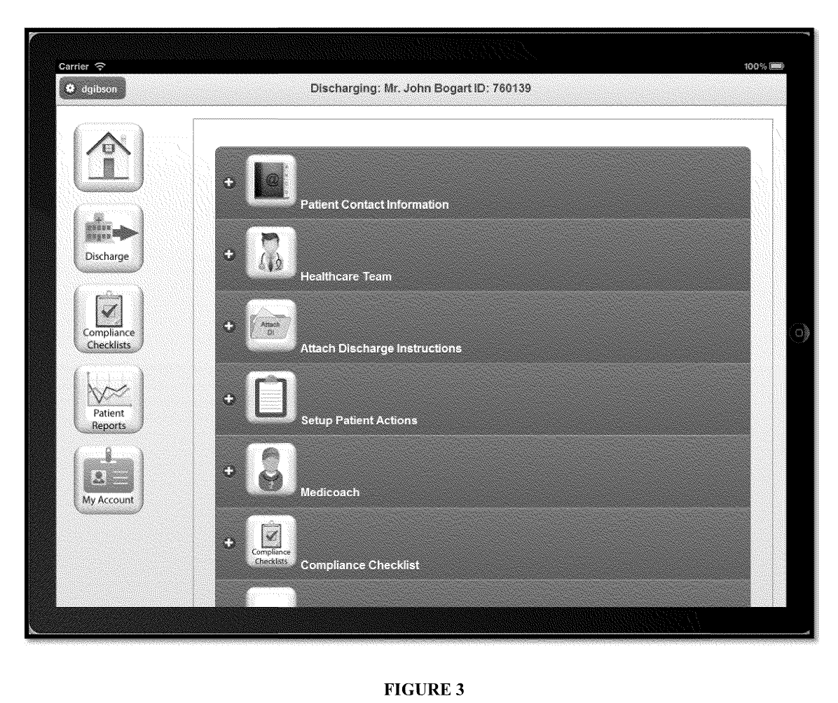

At step 215, the clinician 104 may select a patient 105 to be discharged from the list presented on the clinician device 103. For example, if the clinician device 103 is a tablet computer, the clinician may touch the screen on the device 103 to select the patient 105 who will be discharged. In certain embodiments, the list of patients may be color-coded to differentiate between patients where the discharge process has begun from patients wherein the discharge process has not begun. FIG. 3 shows a screen capture of an exemplary clinician interface 106 as displayed on the clinician device 103 after a patient 105 has been selected for discharge at this step 215.

At step 225, the clinician interface 106 may begin the interactive process of building patient discharge instructions. In certain embodiments, there may be an intermediate step 220, between steps 215 and 225, wherein the clinician interface 106 may transmit the clinician's selection to the hospital server 101 via the hospital network 107 prior to commencing the discharge process. In other embodiments, the clinician interface 106 may skip this step 220 and conduct all of the steps of discharge (e.g., 225-255, as described below) prior to transmitting the clinician's patient selection and other discharge information to the hospital server 101.

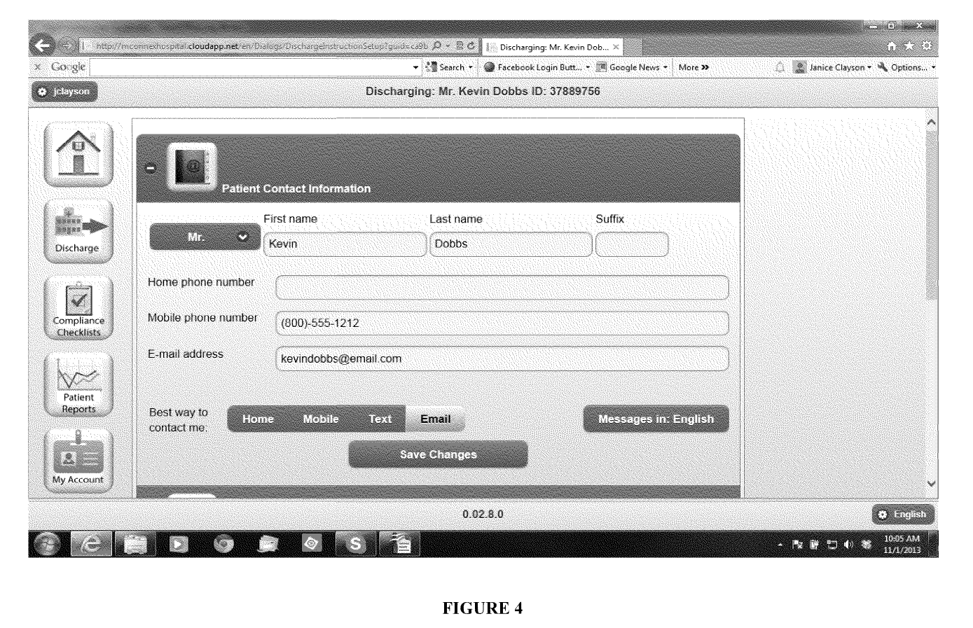

Thus, at step 225, the patient's contact information may be populated into the clinician interface 106. In some embodiments, the clinician 104 may enter this information. In other embodiments, the clinician 104 may give the clinician device 103 to the patient 105, who can then enter his or her contact information (such as, for example, a home or mobile telephone number and/or an email address) into the clinician interface 106. In still other embodiments, including those wherein step 220 has been performed, the hospital server 101 may populate the clinician interface 106 with the patient's contact information as stored in the patient's medical records. FIG. 4 shows a screen capture of an exemplary clinician interface 106 as displayed on the clinician device 103 after a patient's contact information has been populated into the interface 106 at this step 225.

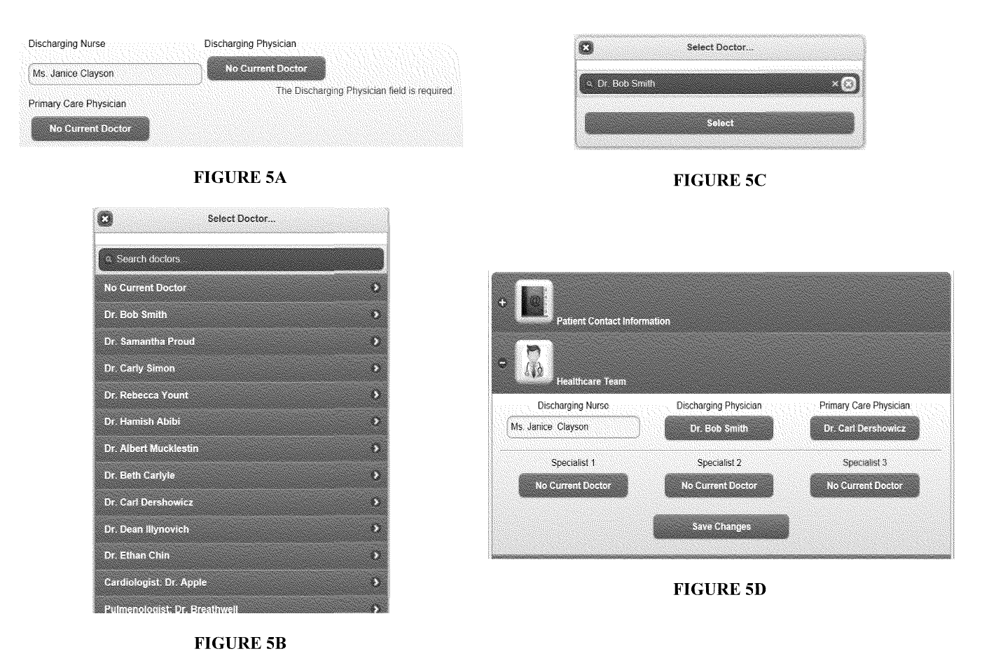

As shown on FIG. 2B, at step 230, one or more clinicians may be associated with the patient 105 as a “healthcare team” within the clinician interface 106. For example, the clinician 104 may be associated with the patient 105 as the “discharge clinician.” If the clinician 104 is a nurse or other non-physician, a physician may also be associated with the patient 105 as the “discharge physician.” In certain embodiments, the discharge physician may be selected from a drop down box located on the clinician interface 106. Additionally, the patient's primary care physician and any relevant specialists also may be associated with the patient 105. This step of associating a healthcare team with the patient 105 may be performed by the clinician 104, or may be performed by the patient 105 with the assistance of the clinician 104. A healthcare team may include one or more physicians, nurses, physician's assistants, medical technician, or the like. A healthcare team may also include a specialist referred for patient 105 follow-up care. FIGS. 5A-5D show screen captures of an exemplary clinician interface 106 during the process of setting up the patient's healthcare team during this step 230.

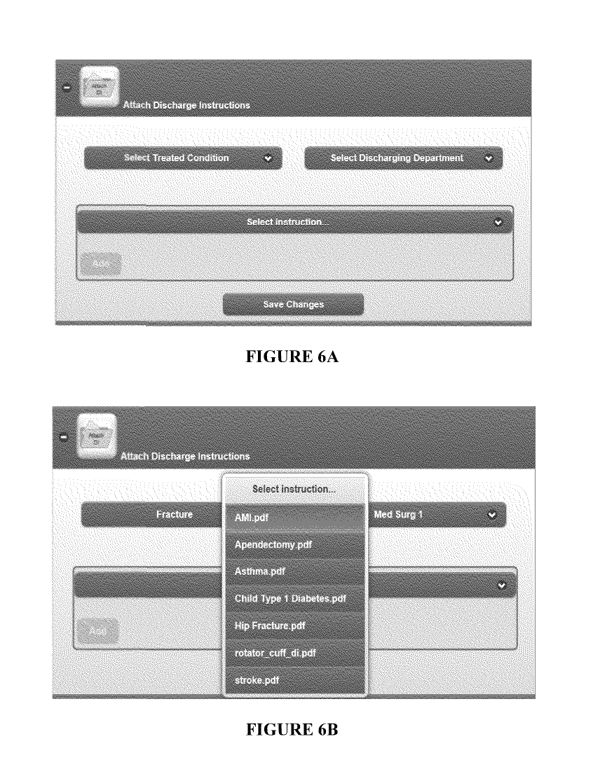

At step 235, the patient's discharge instructions may be created by selecting a “treated condition,” i.e., a condition for which the patient 105 received treatment while admitted to the hospital 102 (e.g., influenza, stroke, fracture, etc.); the “discharge department,” i.e., the hospital department from which the patient 105 is being discharged (e.g., the Emergency Room); and appropriate “discharge instructions” for the patient containing information such as what their condition is, how to manage their recovery, medications that may be prescribed, etc. This step of creating the discharge instructions may be performed by the clinician 104, or may be performed by the patient 105 with the assistance of the clinician 104. The patient's discharge instructions may include a follow up visit with a specialist, a surgeon, or a pharmacist. The patient's discharge instructions may include obtaining additional diagnostic tests such as blood work, an X-ray, a CAT scan, an MRI, or the like. Any discharge instructions may be attached to a Discharge Summary Report. In one embodiment, a clinician may schedule the patient's follow up visit using the clinician interface 106. In another embodiment, the patient may receive an alert on his or her patient device 112 as a reminder to schedule any recommended follow-up visits. FIGS. 6A and 6B show screen captures of an exemplary clinician interface 106 during this step 235.

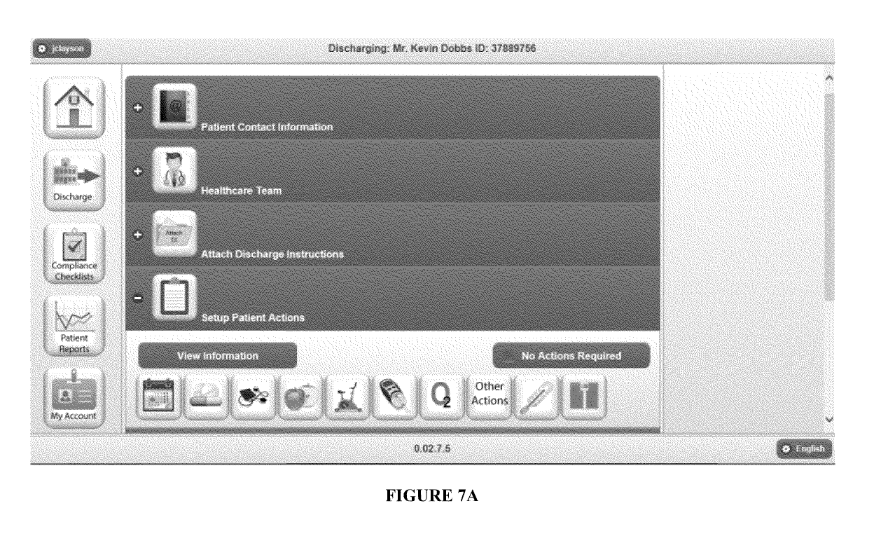

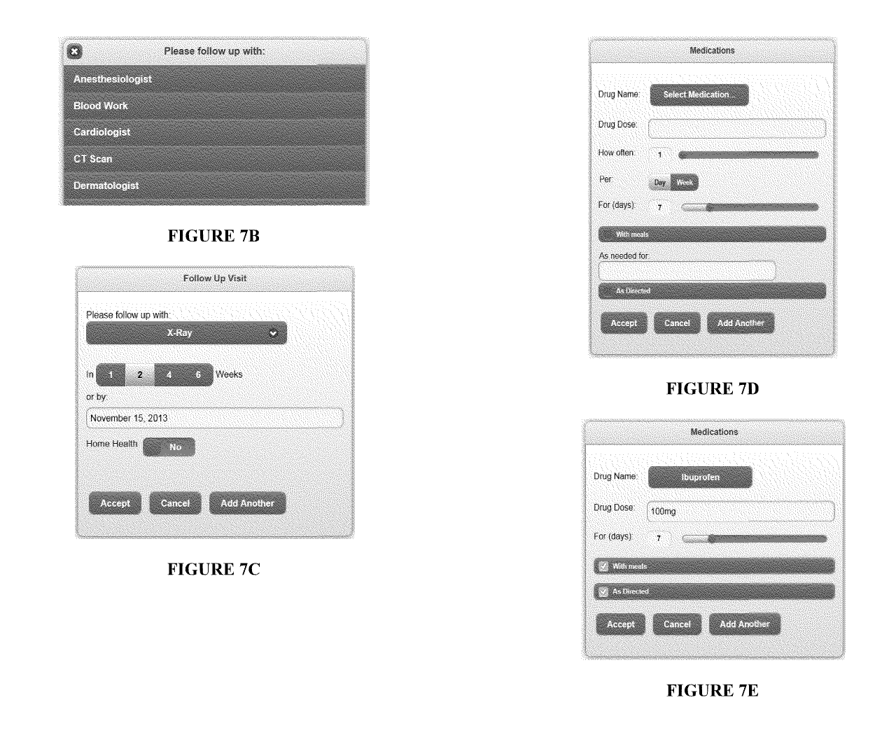

At step 240, certain “patient actions” may be associated with the patient 105, i.e., actions which the patient may be required to follow as part of their recovery after discharge (e.g., follow-up visit, medications, blood pressure monitoring, diet monitoring, blood-glucose monitoring, oxygen therapy, physical activity, etc.). This step of associating patient actions with the patient 105 may be performed by the clinician 104, or may be performed by the patient 105 with the assistance of the clinician 104. In one embodiment, a patient action may include a drug dosage to be followed by the patient. A drug may be prescription drug or an over the counter drug. A patient action may include instructions about when and how to take a drug, and/or how and when to monitor blood pressure, diet, blood-glucose, and the like. Further, a patient action may include dietary restrictions such as sodium, fat, and caloric restrictions. A patient action may also include physical activity guidelines, when and how to take their body temperature, or when and how to receive oxygen therapy. A patient may receive alerts if they fail to acknowledge compliance with a recommended patient action. A clinician may be allowed to view the number of alerts sent to his or her patients through the clinician interface 106. Patient alerts may be viewed as a table or a chart. FIGS. 7A-7E show screen captures of an exemplary clinician interface 106 during this step 240. These steps 235 and 240 may be repeated as necessary in the event that the patient 105 has multiple treated conditions which require separate or independent discharge instructions.

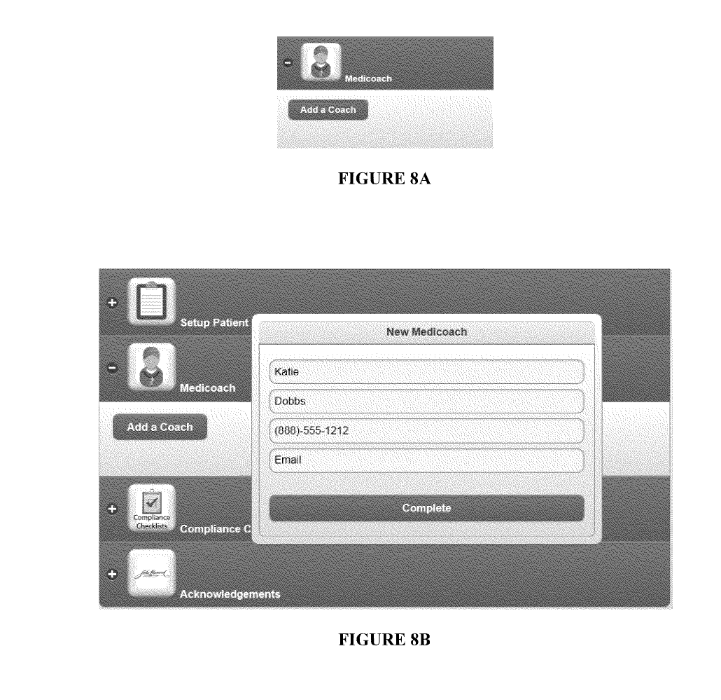

At step 245, a medical coach 110 may be associated with the patient 105. The medical coach 110 may receive notifications of certain patient-related events such as, for example, when the patient fails to respond to daily or weekly updates in regards to their directions at discharge, or if the patient is incapable of responding to phone, text, or email notifications. In certain embodiments according to the present disclosure, the medical coach 110 may receive such notifications via a discharge notification device 111. These messages may be in any suitable format including, but not limited to, the form of voicemail, email, text message, telecommunications device for the deaf (TDD), or a combination thereof. The medical coach 110 also may be able to assist the patient 105 with understanding the patient's discharge instructions, e.g., as created at step 235, and/or may assist the patient 105 with complying with one or more patient actions, e.g., as created at step 240. In certain embodiments, the medical coach 110 also may monitor the patient's compliance with discharge instructions and communicate the level of compliance to the global server 108 or the hospital server 101, e.g., by using a discharge notification device 111. The medical coach 110 further may send compliance reminders to the patient device 112 in any suitable format including, but not limited to, the form of voicemail, email, text message, telecommunications device for the deaf (TDD), or a combination thereof. The medical coach 110 may be anyone accessible to the patient 105 such as, without being limiting, the patient's spouse, child, sibling, neighbor, or friend. This step of associating an medical coach 110 with the patient 105 may be performed by the clinician 104, or may be performed by the patient 105 with the assistance of the clinician 104. FIGS. 8A and 8B show screen captures of an exemplary clinician interface 106 during this step 245.

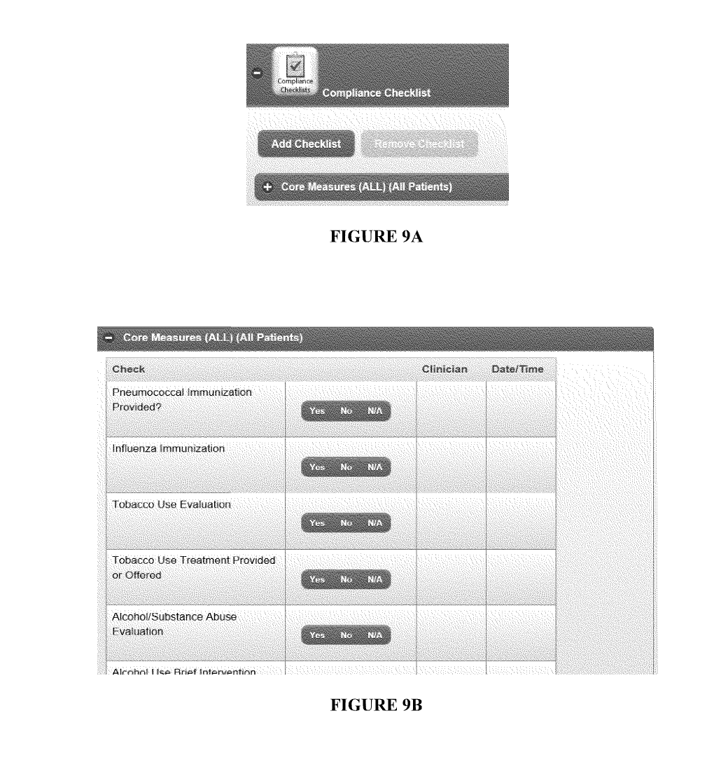

At step 250, the clinician 104 may review a compliance checklist. For example, the clinician 104 may review whether the patient 105 has received all required immunizations, whether the patient 105 requires tobacco use treatment or alcohol/substance abuse evaluation, whether the patient 105 is following a prescription drug or diet regimen, etc. FIGS. 9A and 9B show screen captures of an exemplary clinician interface 106 during this step 250.

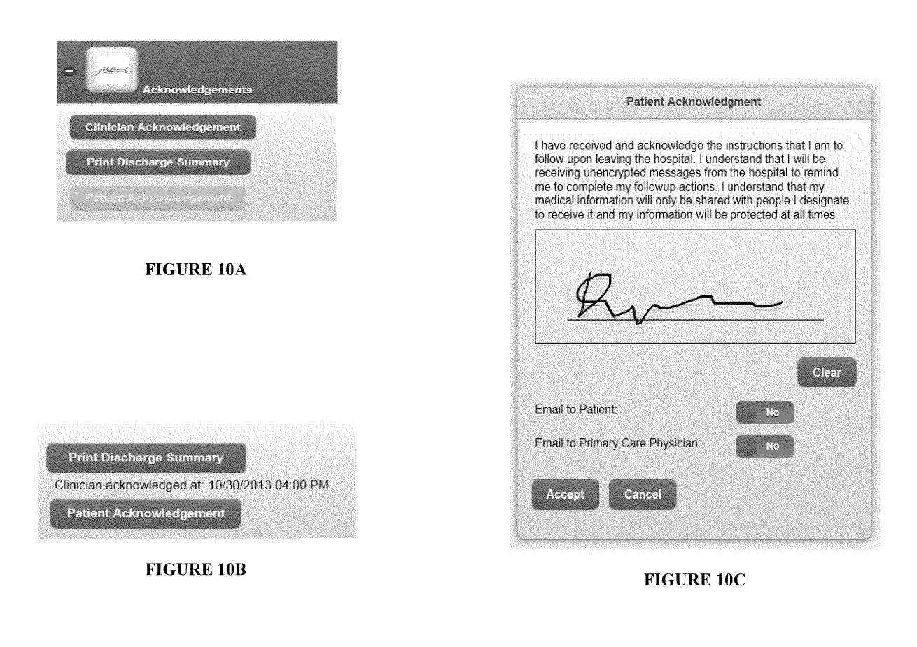

At step 255, the clinician 104 and the patient 105 may perform their final review and acknowledgments of the discharge. The clinician 104 may verify that all members of the healthcare team are correct, may verify that the appropriate discharge instructions have been selected, etc. The patient 105 may acknowledge that the discharge instructions have been communicated clearly and fully understood. Conversely, the patient 105 may indicate that they do not understand the instructions or have unanswered questions, and appropriate actions may be taken to resolve the patient's concerns. The patient 105 may print a discharge summary and/or elect to have it e-mailed to him or herself, and may certify receipt of the discharge summary. FIGS. 10A-10C show screen captures of an exemplary clinician interface 106 during this step 255. Upon completion of the clinician 104 and patient 105 acknowledgements, the discharge process may be complete.

In one embodiment according to the present disclosure, the patient 105 or clinician 104 may change the language of any text displayed on the clinician interface 106, such as any text-based prompts (e.g., “Select Patient”). For example, in one such embodiment, the text of all prompts may be changed from English to Spanish, French, Russian, Portuguese, Dutch, Korean, Chinese or another language of the patient's choice. In yet another embodiment according to the present disclosure, the patient 105 or the clinician 104 may change the language of any discharge instructions displayed on the clinician interface 106 and/or provided to the patient 105. For example, in one such embodiment, the patient's discharge instructions may be changed from English to Russian. The language of the action plan may be toggled between languages while conducting the review with the patient 105, thus enabling the clinician 104 to confirm the accuracy of the action plan in one language and then present it to the patient 105 in another.

In some embodiments according to the present disclosure, the clinician interface 106 may be configured to provide a variety of patient-related reports. For example, the clinician interface 106 may present information including but not limited to:
Patient readmission information and statistics;
A list of alerts sent to discharged patients;
Any patient contraindications to treatment options;
Discharge and compliance information for each discharged patient; and
Post-discharge contact history for each discharged patient.

Once a patient 105 has been discharged, e.g., in accordance with the method described with respect to FIGS. 2A and 2B, the patient 105 may use a patient device 112, through the patient interface 113, to access and/or configure a variety of patient-specific information. To do so, the patient 105 may uniquely identify him or herself to the patient interface 113. For example, the patient 105 may type in a username and password using a virtual or real keypad on the patient device 112, which may be verified on the patient device 112 or by reference to credentials stored on the global server 108. It will be understood, however, that patient authentication can be performed in a variety of different ways already known and understood in the art.

A patient 105 may use the patient interface 113 to configure the frequency and preferred mode of receiving updates and alerts on the patient device 112. The patient 105 may update information periodically, such as, without being limiting, daily, weekly, bi-weekly, or monthly. Information being updated or communicated to a hospital server 101 and/or a global server 108 through the patient device 112 may include, without being limiting, weight, temperature, blood pressure, current prescription or non-prescription medications, acknowledge that a prescription was filled, blood glucose level, etc.

A patient 105 additionally may use a patient device 112 to access discharge instructions, view contact information of their healthcare team, send a message to their healthcare team or medical coach 110, review progress charts or reports, review progress goals and milestones, set reminders, request further instructions or clarification of pending instructions, etc.

A patient 105 further may use the patient device 112 to view and overall action plan, or view instructions for a particular day and/or indicate that a particular day's instructions were followed or were not followed.

In one embodiment according to the present disclosure, the patient 105 may change the language of any text displayed on the patient interface 113, such as any text-based prompts (e.g., “Select Patient”). For example, in one such embodiment, the text of all prompts may be changed from English to Spanish. In yet another embodiment according to the present disclosure, the patient 105 may change the language of any discharge instructions displayed on the patient interface 113. For example, in one such embodiment, the patient's discharge instructions may be changed from English to Farsi. In certain embodiments, a patient 105 may select the language in which they prefer to view the patient interface 113 by selecting a language button of the patient device 112.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims, in which all terms are meant in their broadest reasonable sense unless otherwise indicated therein.

What is claimed:

1. An interactive patient discharge system comprising:
a. at least one hospital server configured to store at least one patient's health information;
b. at least one clinician device, wherein the clinician device is an electronic device configured to communicate via a communications network with the hospital server; and
c. at least one clinician interface, wherein the clinician interface is a web-based portal accessible using the clinician device, and wherein the clinician interface is configured to conduct an interactive patient discharge process.

2. The interactive patient discharge system of claim 1, further comprising at least one global server configured to provide a gateway for external communications.

3. The interactive patient discharge system of claim 1, further comprising at least one discharge notification device configured to receive one or more messages via the global server.

4. The interactive patient discharge system of claim 1, further comprising:
a. at least one patient device, wherein the patient device is an electronic device configured to communicate via a communications network with at least one of the global server and the hospital server; and
b. at least one patient interface, wherein the patient interface is a web-based portal accessible using the patient device, and wherein the patient interface is configured to allow patients to communicate with at least one of the hospital server and the global server.

5. The interactive patient discharge system of claim 4, wherein the patient device and the discharge notification device comprise a unitary electronic device.

6. A method for interactively discharging a patient using a clinician device configured to operate a clinician interface comprising the steps of:
a. accessing the clinician interface on the clinician device;
b. identifying a discharging clinician to the clinician interface;
c. selecting one or more treated conditions in the clinician interface;
d. generating one or more discharge instructions associated with each treated condition;
e. configuring delivery of discharge instructions to the patient; and
f. acknowledging the patient's receipt of discharge instructions.

7. The method of claim 6, further comprising presenting on the clinician interface a list of patients to be discharged.

8. The method of claim 7, further comprising selecting from the list of patients a patient to be discharged.

9. The method of claim 6, further comprising associating one or more clinicians with the patient in the clinician interface.

10. The method of claim 6, further comprising providing the clinician device to the patient.

11. The method of claim 6, further comprising populating the patient's contact information in the clinician interface.

12. The method of claim 6, further comprising associating a coach with the patient.

13. The method of claim 12, further comprising providing the coach with a discharge notification device configured to receive one or more messages.

14. The method of claim 6, further comprising reviewing a compliance checklist.

15. The method of claim 6, further comprising selecting one or more patient actions in the clinician interface.

16. The method of claim 6, further comprising translating the discharge instructions into a language preferred by the patient.

17. A method of increasing compliance with discharge instructions in a patient comprising:
a. providing a patient with discharge instructions;
b. proving the patient with a means to report compliance with the discharge instructions;
c. monitoring patient compliance with discharge instructions through a clinician interface; and
d. sending the patient alerts when the patient fails to comply with the discharge instructions.

18. The method of claim 17, further comprising associating the patient with a coach having a discharge notification device.

19. The method of claim 18, further comprising sending alerts to the coach's discharge notification device.
